(19) United States
(12) Patent Application Publication
(10) Pub. No.: US 2024/0230706 A9
(43) Pub. Date: Jul. 11, 2024

(54) PHOTONIC ACCELEROMETER

(71) Applicant: Southern Methodist University, Dallas, TX (US)

(72) Inventors: Jaime da Silva, Dallas, TX (US); Dominique Fourguette, Stevenson Ranch, CA (US); Volkan Otugen, Dallas, TX (US); Bruce Gnade, Lewisville, TX (US)

(21) Appl. No.: 18/491,495

(22) Filed: Oct. 20, 2023

Related U.S. Application Data
(60) Provisional application No. 63/417,777, filed on Oct. 20, 2022.

(51) Int. Cl. G01P 15/093; G01P 15/18

(52) U.S. Cl. CPC G01P 15/093; G01P 15/18

(57) ABSTRACT

Photonic accelerometers and systems containing the same are described herein. In one aspect, a photonic accelerometer includes: a resonator; a waveguide evanescently coupled to the resonator; a cantilever supporting the resonator, the cantilever including: (i) a first end fixed to a base, and (ii) a second, free end; and a proof mass supported by the free end of the cantilever. The resonator can be configured to store resonant photons in a mode at a resonant frequency. The waveguide can be configured to guide photons proximate the resonator to coupled resonant photons into the mode. The proof mass can be configured to deflect the cantilever based on motion of the base, where deflections of the cantilever cause shifts of the resonant frequency.

### CROSS-REFERENCE TO RELATED APPLICATION

This application claims the benefit of U.S. Provisional Application No. 63/417,777, filed Oct. 20, 2022, the contents of which are incorporated by reference herein.

### BACKGROUND

This specification generally relates to photonics-based accelerometers, e.g., configured as seismometers and other motion sensors.

Accelerometers are employed in numerous systems to detect and monitor motion such as handheld and mobile devices, navigation systems, structural monitoring, seismology, gravimetry, and medical and biological sciences, to name a few.

In modern applications, miniaturized accelerometers with high sensitivity and low power consumption are desirable for accurate and continuous monitoring of motion or other disturbances. However, achieving such features over a broad bandwidth while remaining resistant to ambient conditions, e.g., temperature, pressure, and electromagnetic interference, is a significant challenge.

### SUMMARY

This specification describes photonic accelerometers and systems containing the same that can provide robust measurement of an object's motion. In the described examples of a photonic accelerometer, the robustness is achieved, at least in part, using a cantilever supporting a high optical quality photonic resonator. Deflections of the cantilever cause resonant frequency shifts in a modal spectrum of the resonator due to changing the resonator's morphology, e.g., a dimension and/or a refractive index of the resonator. These mode shifts can be characterized by coupling (e.g., evanescently coupling) a waveguide to the resonator, supplying and collecting photons from a respective input and output of the waveguide, and measuring the resulting transmission spectrum over multiple sampling steps. Due to the efficiency and speed of modern photonic devices, resonant frequency shifts can be monitored continuously at high sampling rates to accurately discern the motion of the object generating the deflections. An adjustably sized proof mass can be supported by a free end of the cantilever to achieve a desired level of sensitivity and bandwidth for the photonic accelerometer.

In general, in a first aspect, the disclosure features a photonic accelerometer including: a resonator configured to store resonant photons in a mode at a resonant frequency; a waveguide configured to guide photons proximate the resonator to couple resonant photons into the mode; a cantilever supporting the resonator, the cantilever including: (i) a first end fixed to a base, and (ii) a second, free end; and a proof mass supported by the free end and configured to deflect the cantilever based on motion of the base. Deflections of the cantilever causing shifts of the resonant frequency.

Implementations of the photonic accelerometer can include one or more of the following features and/or features of other aspects. For example, the resonator can be a ring resonator and the mode can be a whispering-gallery mode (WGM). In other examples, the resonator can be a disk resonator or a transmission line resonator.

The resonator can be supported by the cantilever and the base. The waveguide can be supported by the base.

In some cases, deflections of the cantilever can change a morphology of the resonator. The resonant frequency can depend, at least in part, on the morphology of the resonator. The morphology of the resonator can include at least one of: a dimension of the resonator or a refractive index of the resonator.

In some implementations, the photonic accelerometer further includes: a light source configured to supply photons to an input of the waveguide; and a photodetector configured to collect photons from an output of the waveguide.

In further implementations, the photonic accelerometer includes an electronic control module communicatively coupled with the light source and photodetector. The electronic control module can be configured to correlate supplied and collected photons to determine the shifts of the resonant frequency.

In yet further implementations, the light source can be configured to supply photons at a monochromatic frequency variable over a frequency band. The electronic control module can be configured, for each of multiple time steps, to: vary the monochromatic frequency over the frequency band; and determine a transmission spectrum between: (i) photons supplied to the input of the waveguide, and (ii) photons collected from the output of the waveguide.

In some examples, the photodetector can be a p-n photodiode, a p-i-n photodetector, or a metal-semiconductor-metal (MSM) photodetector.

In some examples, the light source can be a diode laser, a dye laser, or a semiconductor laser.

In some implementations, the cantilever can be a photonic chip that includes a layer of cladding and a layer of substrate. The resonator and waveguide can be embedded in the layer of cladding. The layer of substrate can be attached to the base.

The layer of cladding can include silica. The layer of substrate can include silicon.

In some examples, the waveguide can be a dielectric waveguide. The dielectric waveguide can be an optical fiber.

In further examples, the dielectric waveguide can include at least one of: silicon or silicon nitride.

In other examples, the resonator can include at least one of: silicon or silicon nitride.

In some cases, the motion of the base can be generated from seismic activity.

In a second aspect, the disclosure features a method for measuring motion of an object using a photonic accelerometer. The method includes: guiding, using a waveguide, photons proximate a resonator to couple resonant photons into a mode supported by the resonator; storing, using the resonator, the resonant photons in the mode at a resonant frequency, deflecting, using a proof mass, a cantilever supporting the resonator, the cantilever including: (i) a first end fixed to a base, and (ii) a second, free end supporting the proof mass, where the base is secured to the object, and where the proof mass is configured to deflect the cantilever based on motion of the base, deflections of the cantilever causing shifts of the resonant frequency.

Implementations of the method can include one or more of the following features and/or features of other aspects. For example, the method can include: supplying, using a light source, photons to an input of the waveguide; and collecting, using a photodetector, photons from an output of the waveguide.

In further examples, the method can include: correlating, using an electronic control module communicatively coupled with the light source and photodetector, supplied and collected photons to determine the shifts of the resonant frequency.

In some implementations, the light source can be configured to supply photons at a monochromatic frequency variable over a frequency band. The electronic control module can be configured, for each of multiple time steps, to: vary the monochromatic frequency over the frequency band; and determine a transmission spectrum between: (i) photons supplied to the input of the waveguide, and (ii) photons collected from the output of the waveguide.

In a third aspect, the disclosure features a triaxial photonic accelerometer including: a base configured to move in three mutually orthogonal directions; and three photonic accelerometers each including: a resonator configured to store resonant photons in a mode at a resonant frequency; a waveguide configured to guide photons proximate the resonator to couple resonant photons into the mode; a cantilever supporting the resonator, the cantilever including: (i) a first end fixed to the base, and (ii) a second, free end; and a proof mass supported by the free end and configured to deflect the cantilever in one of the three mutually orthogonal directions based on motion of the base, deflections of the cantilever causing shifts of the resonant frequency.

In a fourth aspect, the disclosure features a sensor network including multiple photonic accelerometers. Each photonic accelerometer includes: a resonator configured to store resonant photons in a mode at a resonant frequency; a waveguide configured to guide photons proximate the resonator to couple resonant photons into the mode; a cantilever supporting the resonator, the cantilever including: (i) a first end fixed to a base, and (ii) a second, free end; and a proof mass supported by the free end and configured to deflect the cantilever based on motion of the base, deflections of the cantilever causing shifts of the resonant frequency.

Particular embodiments of the subject matter described in this specification can be implemented so as to realize one or more of the following advantages.

The photonic accelerometers described herein are compact, rugged, low power, highly sensitive, and resistant to electromagnetic interference. Moreover, they can operate in conditions where conventional accelerometers (e.g., seismometers) are either limited or infeasible, e.g., in extreme temperature and/or pressure environments. Since the photonic accelerometers are compatible with modern telecommunications they can be operated remotely, for example, when environmental conditions are too harsh for human involvement. The disclosed photonic accelerometers are amenable to modern microfabrication technologies, such as those employed in silicon photonics (e.g., lithography and/or chemical vapor deposition), which admits inexpensive, large-scale production, as well as material optimization to ensure thermomechanical stability and optomechanical robustness. The photonic accelerometers can also be straightforwardly extended into networks of sensors interconnected by one or more waveguides (e.g., optical fibers or other dielectric waveguides) which can provide sensing over multiple bandwidths in multiple locations simultaneously. The signal-to-noise ratios of the disclosed accelerometers are not dependent on the amplitude of accelerations and therefore can measure small and/or slowly-varying motional fluctuations over an extended period of time.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a top view depicting an example of a photonic accelerometer.

FIG. 1B is a cross-sectional view depicting the example photonic accelerometer of FIG. 1A.

FIG. 2 is a schematic view depicting an example of a measurement system that includes a photonic accelerometer for sensing motion.

FIGS. 3A and 3B are plots of experimental data showing mode shifts vs. acceleration of an object.

FIG. 4 is a flow diagram of an example process for measuring motion of an object using a photonic accelerometer.

FIG. 5 is a flow diagram of an example process for determining mode shifts of a photonic accelerometer.

FIG. 6 is a flow diagram of an example process for generating transmission spectrums of a photonic accelerometer.

FIG. 7 is an isometric view depicting an example of a triaxial photonic accelerometer.

FIG. 8 is a schematic view depicting an example of a sensor network that includes multiple multiplexed photonic accelerometers as sensor elements. Like reference numbers and designations in the various drawings indicate like elements.

### DETAILED DESCRIPTION

Accelerometers are instruments that can detect and measure the motion of an object, e.g., proper acceleration of the object. Proper acceleration refers to the acceleration of the object measured in its own instantaneous rest frame. For example, an accelerometer attached to an object residing on the surface of Earth measures an acceleration due to Earth's gravity (g) directly upwards, while the accelerometer measures zero acceleration if the object is in freefall. Accelerometers can also be calibrated as force sensors to measure applied forces on an object according to Newton's second law F=Ma, where F is the applied force, M is the object's mass, and a is the object's acceleration. Herein, boldface indicates a vector quantity.

Accelerometers have many applications in commercial, industrial, and scientific systems, e.g., detecting motion in mobile devices to count steps and/or stabilize camera image capture; measuring vibrations in vehicles, machines, and buildings to monitor structural integrity and health; remote sensing, inertial navigation systems, gravimetry, seismology, and numerous others.

In seismology, accelerometers are typically referred to as seismometers that are tuned to measure seismic activity (e.g., ground noises, shaking, and vibrations) caused by earthquakes, volcanic eruptions, explosions, and other phenomena. Seismometers can be combined with timing and recording devices to generate seismograms, e.g., transient data describing seismic activity over time.

Seismometers are ubiquitous on Earth and have witnessed increasing usage in government and private-led planetary exploration missions. Modern seismometers often include spring-mass active devices that employ an electromechanical feedback force unit. The force unit inhibits the motion of a proof mass responding to ground motion—the force maintaining the proof mass at rest characterizes the ground motion, e.g., according to Newton's second law mentioned above. Owing to a closed-loop circuit, the frequency response of such seismometers can be configured to cover a desired band of seismic events, e.g., the 0.1 Hertz (Hz) to 40 Hz band. However, additional circuitry introduces both electronic noise and heat generation due to electrical power dissipation. On the other hand, traditional passive seismometers, e.g., geophones, typically involve amplifiers to facilitate a suitable signal-to-noise ratio. Amplifiers can increase the size, complexity, power consumption, and heat generation of seismometers and are usually avoided when possible.

The photonic accelerometers (e.g., configured as seismometers or other motion sensors) outlined in this specification present an attractive alternative to these aforementioned electromechanical (and other traditional) methods as they eliminate the need for electronics near the sensing element and/or some electronics altogether, e.g., amplifiers. Susceptibility to ambient conditions (e.g., temperature and/or pressure), is another common issue affecting conventional seismometers. One of the main benefits of the disclosed photonic accelerometers is that they can operate in conditions where conventional seismometers are either limited or infeasible. For example, in applications involving extreme temperatures, the photonic accelerometer's materials (e.g., dielectric materials) can be optimized such that thermomechanical phenomena do not significantly affect performance, e.g., such that a change of a dimension or a mechanical property of the photonic accelerometer is negligible while it is subjected to an extreme temperature regime.

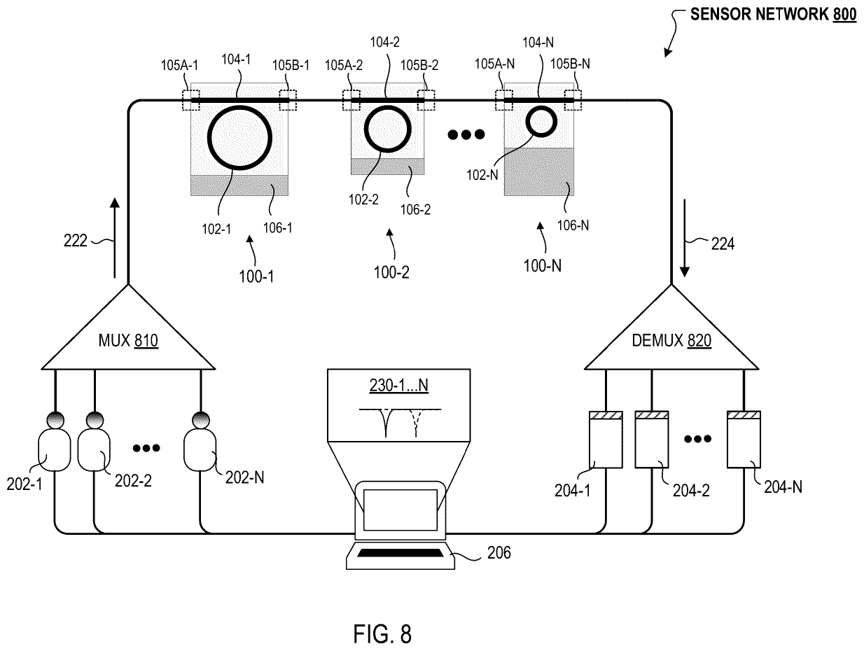

The photonic accelerometers described herein are compact, rugged, low power, highly sensitive, and resistant to electromagnetic interference. They use high optical quality photonic resonators that offer high measurement resolutions over large bandwidths. In addition, multiple photonic accelerometers, interconnected by low-loss dielectric waveguides (e.g., optical fiber networks) can be deployed at great distances from the optoelectronic processing systems. The all- optical input-output connections allow the accelerometers to be multiplexed into sensor networks (see FIG. 8 for example). The versatility of photonic resonator sensing also admits the integration of reference photonic sensors to compensate for variations in ambient conditions (e.g., temperature and/or pressure) that may affect the output signal, providing even higher sensing sensitivity.

These features and other features relating to photonic-based accelerometers are described in more detail below.

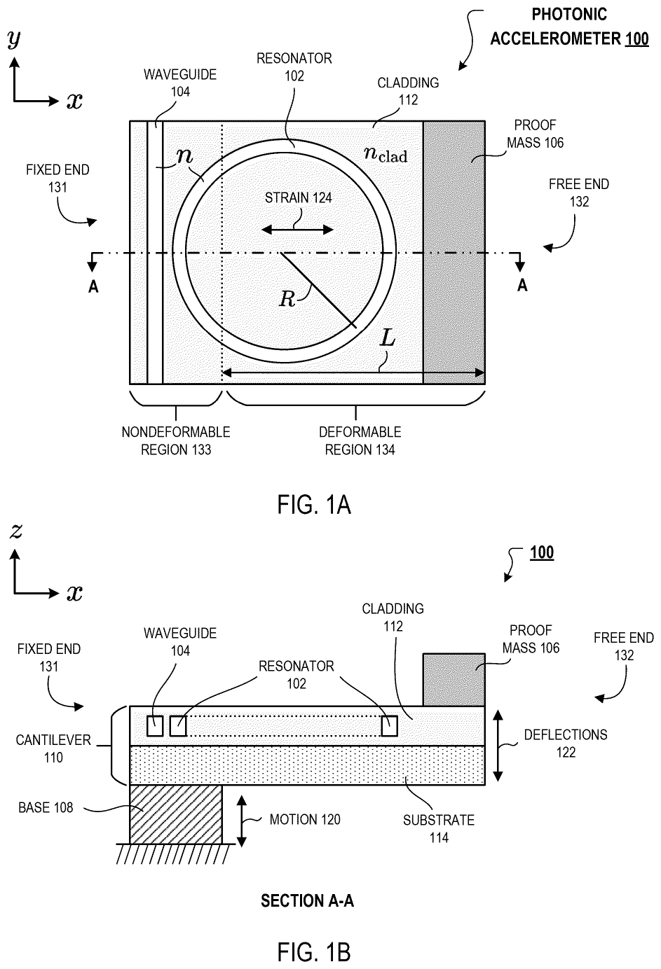

FIG. 1A is top view showing an example of a photonic accelerometer 100 that can accurately and efficiently characterize an object's motion, e.g., proper acceleration of the object. FIG. 1B is a cross-sectional view of the example accelerometer 100 shown in FIG. 1A. For clarity, reference will be made to both FIGS. 1A and 1B when describing various components and functions of the photonic accelerometer 100.

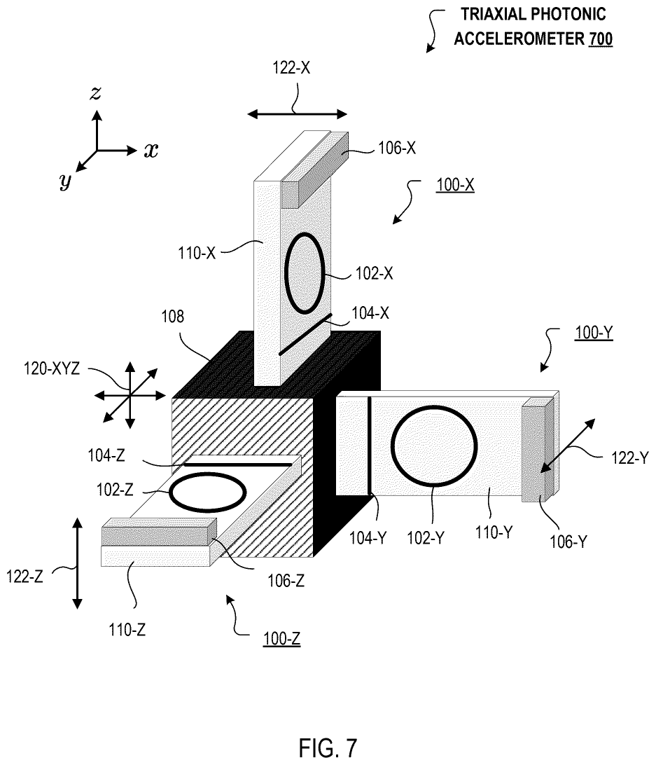

Accelerometer 100 is a single-axis device that measures motion 120 of a base 108 in a single direction, in this case, the z-direction when referring to the Cartesian coordinate system depicted in FIGS. 1A-1B. However, as is explained with reference to FIG. 7, three accelerometers 100 can be employed as a triaxial accelerometer to measure motion in three mutually orthogonal directions, e.g., in the x, y, and z directions.

Base 108 can be secured to an object such that motion 120 of the base 108 corresponds to motion of the object. The base 108 can be permanently secured to the object (e.g., by fabricating the accelerometer 100 on the object) or temporarily secured to the object (e.g., using releasable fasteners). The object can compose and/or be a component of any system where motion and/or force detection is desired, such as any of the example systems mentioned above.

Accelerometer 100 includes a rectangular cantilever 110 with a first end 131 fixed to the base 108 transversely along the z-direction. The first end 131 is fixed in a manner such that a nondeformable region 133 is supported by the base 108 and a deformable region 134 overhangs the base 108. Although the first end 131 can be fixed to the base 108 laterally, e.g., along the x-direction, this configuration possesses a few advantages: (i) mechanical integrity due to generating perpendicular shear stresses in the cantilever 110 relative to the base 108, and (ii) accommodating regions of minimal strain (e.g., nondeformable region 133) and nonzero strain (e.g., deformable region 134). Thus, components located in the nondeformable region 133 do not exhibit significant, if any, mechanical stresses during normal (e.g., elastic deforming) operation of the photonic accelerometer 100.

A proof mass 106 is supported by a second, free end 132 of the cantilever 100 and is configured to deflect 122 the cantilever 110 based on motion 120 of the base 108. The proof mass 106 is a known quantity of mass and is used by accelerometer 100 as a reference for measurement. The size and location of the proof mass 106 about the free end 132 can be adjusted to achieve a desired level of sensitivity and bandwidth for the accelerometer 100. As shown in FIGS. 1A-1B, deflection 122 of the cantilever 110, resulting from inertia of the proof mass 106, generates strain 124 in the deformable region 134. The local strain 124 in the cantilever 110 can be negative (compressive) or positive (tensile), or oscillate between the two, depending on how the cantilever 110 is deflected 122 by the proof mass 106.

For a rectangular cantilever 110 described by Euler-Bernoulli (EB) beam theory, e.g., for small deflections 122 and transverse loading, the mechanical strain 124 in the deformable region 134 can be expressed (approximately) as,

ϵₓₓ(x)=−z d²w(x)/xdx²

x is the coordinate along the overhanging length of the cantilever 110 and z is the transverse distance from the neutral axis (zero stress plane). w(x) is the deflection 122 of the cantilever 110 as a function of x caused by the transverse load (P) at the free end 132,

w(x)= Px²/6EI(3L−x)

E, I, and L are the Young's modulus, area moment of inertia, and length of the cantilever 110 overhang, respectively, all of which can be adjusted for a particular implementation. The applied load P is generated from acceleration of the proof mass 106.

The above equations indicate that the local strain 124 is linearly proportional to the load P for small deflections 122. The equation of motion of the cantilever 110 can be expressed in terms of the free end 132 tip displacement q=w (L) relative the motion 120 of the base 108,

$$\ddot{q} + \frac{{ω}_{n}}{Q} \dot{q} + {ω}_{n}^{2} q = - \ddot{u}$$

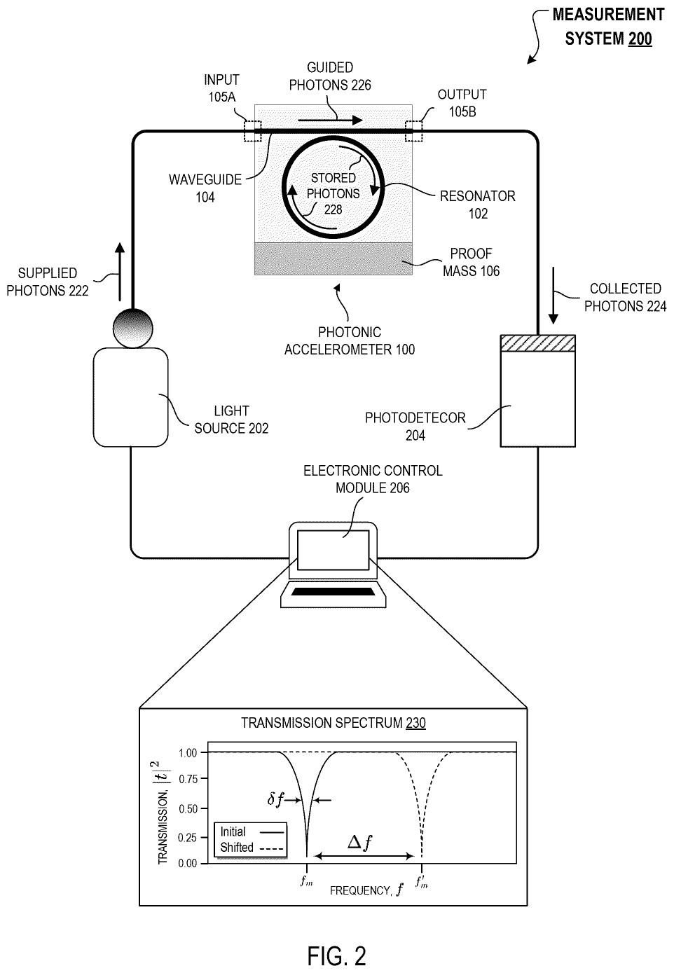

An overdot denotes derivative with respect to time, ωₙ is the first vibrational mode of the undamped cantilever 110, Q is the mechanical quality factor of the accelerometer 100, and ü is the acceleration of the base 108. Parameters ωₙ and Q depend on material properties (e.g., elasticity and dimensions) and characterize the mechanical response of cantilever 110 due to motion 120 of the base 108. These parameters can be empirically determined, for example, using an impulse response experiment where a calibrated impulse force is applied to the proof mass 106 and the oscillations of the cantilever 110 are measured, e.g., using the measurement system 200 in FIG. 2. Note, in general, sufficiently high damping Q≲10 to suppress the vibrational mode peak amplitude and free oscillatory behavior of the cantilever 110 is beneficial for stability. Intrinsic damping mechanisms can include losses from the thermoelastic effect, air-cantilever interaction, internal material friction, and other factors (e.g., cantilever-to-base energy transfer). Examples of other damping mechanisms that can be introduced to increase damping are described below.

From the above equations, it can be shown that the local strain 124 is linearly proportional to the free end 132 tip displacement:

$${ϵ}_{xx} ( x ) = - 3 \frac{zq}{{L}^{3}} ( L - x )$$

Hence, the cantilever 110 is deflected 122 by the proof mass 106 due to motion 120 of the base 108, which in turn generates strain 124 directly proportional to the defections 122.

Granted, rectangular shapes are useful from an application and manufacturing standpoint, various cantilever 110 geometries can be implemented as warranted. For example, the cantilever 110 can have a tapered width from the fixed end 131 to the free end 132 to facilitate uniform strain 124 throughout deformable region 134. Material selection, thickness, width, and overhanging length can be tuned to accommodate different mechanical properties of the cantilever 110, e.g., compliancy, maximum elastic deformation, maximum tip displacement of the free end 132, etc. This design variability and scalability is another noteworthy advantage as the photonic accelerometer 100 can be implemented in a number of diverse settings with different measurement requirements, e.g., amplitude, frequency, bandwidth, sensitivity, level of uncertainty, etc.

Note, photonic accelerometer 100 can include other features and/or components to improve functionality and mechanical performance. For example, to avoid any risk of plastically deforming the cantilever 110, the accelerometer 100 can include mechanical stops that limit the maximum deflection 122. Alternatively, or in addition, if selected materials have low intrinsic damping, additional damping mechanisms can be incorporated into the cantilever 110 without significantly affecting sensitivity. As one example, a damping block (e.g., a polydimethylsiloxane (PDMS) slab) positioned between the proof mass 106 and a contact surface can increase mechanical damping. As another example, the squeeze film effect can be utilized to introduce dynamic damping to the cantilever 110. That is, a surface of the cantilever 110 can be in close proximity to another surface and separated by an air film. The air film generates a reaction force against the surfaces to inhibit movement tendency of the cantilever 110. As yet another example, the accelerometer 100 can be placed in a pressurized air (or other suitable gas) container to increase viscous damping. These damping mechanisms can enhance accelerometer 100 performance while still allowing it to operate passively.

In the described example of the photonic accelerometer 100 depicted in FIGS. 1A-1B, the cantilever 110 is a photonic chip composed of a layer of cladding 112 and a layer of substrate 114. A high optical quality factor resonator 102 and a dielectric waveguide 104 are embedded in the cladding 112 and encompass the primary photonic sensing elements. The substrate 114 supports the cladding 112 and is attached to the base 108. Substrate 114 provides the majority of the mechanical properties of cantilever 110 and can be optimized (e.g., dimensions and/or materials) to realize a certain level of mechanical performance.

Cladding 112 and substrate 114 are depicted in FIG. 1B with similar thicknesses but cladding 112 can be relatively thin comparatively. For example, the substrate 114 thickness can be about 500 microns (μm) or less (e.g., about 400 μm or less, about 300 μm or less, about 200 μm or less, about 100 μm or less, about 50 μm or less) and the cladding 112 thickness can be about 10 μm or less (e.g., about 9μm or less, about 8μm or less, about 7μm or less, about 6μm or less, about 5μm or less, about 2.5 μm or less). This compact form factor is achievable due to the planar-like photonic elements that lend themselves to microfabrication technologies, such as those used in silicon photonics. Semiconductor fabrication techniques can be leveraged for all aspects of photonic accelerometer 100, e.g., lithography and/or chemical vapor deposition methods. These techniques allow for multiple sensing elements (e.g., multiple resonators and one or more waveguides) to be fabricated in a single wafer, making the photonic accelerometer 100 suitable for inexpensive, large-scale production. The photonic chip based cantilever 110 can be fabricated by deposition of glass films, ensuring optomechanical robustness and resistance to electromagnetic interference.

Furthermore, owing to the versatility of photonic chips, one or more additional (e.g., reference) resonators can be implemented in the accelerometer 100 and coupled to the waveguide 104. The one or more additional resonators can measure and offset the effects of undesirable external events such as variations in measured signals due to ambient conditions (e.g., temperature and/or pressure). This can further improve the accuracy, sensitivity, and operating range of the accelerometer 100. For example, a reference resonator detuned from the motion sensing resonator 102 can by embedded in the cladding 112 and positioned in the nondeformable region 133 such that it does not experience deformations while accelerometer 100 is subject to loading. Variations due to ambient conditions, e.g., the thermoelastic effect, can be measured by the reference resonator and this can be subtracted from the signals measured by the motion sensing resonator 102 to compensate for such variations.

In general, resonator 102 and waveguide 104 can be composed of any suitable dielectric material, e.g., silicon, silicon nitride, combinations thereof, or other semiconducting materials. To ensure total internal reflection within the photonic elements, cladding 112 can be of sufficient thickness and composed of glass compositions such as silica. A primary polymer overcoat, e.g., with a refractive index slightly higher than the cladding 112, can also be applied to surfaces of the cladding 112 to attenuate any stray light propagating within the cladding 112. Other protective layers (e.g., high-performance plastics) may also be applied to cladding 112, e.g., for surface protection and/or additional strength. Substrate 114 can be composed of silicon or other materials having suitable mechanical, optical, and/or thermomechanical properties, e.g., to achieve a certain level of compliancy for cantilever 110 with low variance in different ambident conditions.

Resonator 102 and waveguide 104 can also be supported on a surface of the cantilever 110, though, embedding these components in the cladding 112 provides a number of benefits, e.g., suppressing photon scattering at resonator 102 and/or waveguide 104 boundaries, less abrupt changes in effective refractive indices, protection from the environment, strength and durability, etc. In this implementation, resonator 102 and waveguide 104 are composed of alike dielectric material with the same refractive index n, although different dielectric materials with different refractive indices can also be implemented. A degree of homogeneity simplifies manufacturing processes, but the refractive indices can vary in general to accommodate different photonic properties, e.g., light confinement, coupling efficiencies, phase and/or group velocities, etc.

The refractive index n_{clad} of the cladding 112 is also a design parameter but is generally smaller than the refractive indices of resonator 102 and waveguide 104, that is, n>n_{clad}. This ensures photons are adequately confined to the resonator 102 and waveguide 104 via total internal reflection. The refractive indices can be chosen to achieve a desired numerical aperture NA=\sqrt{n²−n_{clad}²} naiad for the accelerometer 100, which can affect properties such as coupling efficiencies, optical bandwidths, and signal dispersion of the resonator 102 and/or waveguide 104. As a first example, for a cladding 112 composed of silica n_{clad}≈1.46, and a resonator 102 and waveguide 104 composed of silicon n 3.88, the numerical aperture is NA≈3.59. As a second example, for a cladding for a cladding 112 composed of silica n_{clad}≈1.46, and a resonator 102 and waveguide 104 composed of silicon nitride n≈2.02, the numerical aperture is NA≈1.40. For the same configuration, the first example generally provides higher light confinement in the resonator 102 and waveguide 104, but as a result, the second example generally provides higher (evanescent) coupling between the resonator 102 and waveguide 104. The materials, dimensions, and/or configuration of the accelerometer 100 can be optimized, e.g., using simulation software, to meet a threshold level of performance in one or more operating characteristics. For example, multiphysics simulation software, e.g., implementing three-dimensional (3D) finite-element analysis (FEA) techniques, can be used to model the mechanical and/or electromagnetic properties of the accelerometer 100 for various materials, dimensions, configurations, and/or ambient conditions.

As shown in FIG. 1A, waveguide 104 is positioned in the nondeformable region 133 and serves as input-output conduit for light in to and out of the photonic accelerometer 100. Waveguide 104 is alleviated of mechanical stresses when the cantilever 110 deflects 122, ensuring minimal (or zero) fluctuation in its photonic properties during accelerometer 100 operation. On the other hand, resonator 102 is situated in both the nondeformable region 133 and the deformable region 134 to couple with the waveguide 104 and deform (strain 124) in response to deflections 122. The resonator 102 acts as a strain gauge that monitors deflections 122 due to the transverse load (P) applied by the proof mass 106. Consequently, the electromagnetic properties of the resonator 102 fluctuate based on the mechanical strain 124 which is the main mechanism for photonic sensing of motion 120.

Resonator 102 and waveguide 104 are in close enough proximity to enable evanescent coupling of light. Evanescent coupling implies the evanescent electromagnetic fields immediately external resonator 102 and waveguide 104 overlap to allow photons to couple from the waveguide 104 into the resonator 102. Resonator 102 and waveguide 104 can be within about a decay length of each other's evanescent field to ensure adequate coupling. The relative proximity can be optimized to enhance a coupling coefficient (κ) between the two. Here, the coupling coefficient refers to the amount of light coupled into the resonator 102 relative the amount of light transmitted (t) through the waveguide 104. Assuming approximately lossless coupling, κ and t can be related by |t|²+|κ|²=1.

Resonator 102 supports one or more electromagnetic modes that can circulate and/or store resonant photons. Electromagnetic modes correspond to stable electromagnetic field distributions in the resonator 102, e.g., distributions that reproduce themselves after a round trip in the resonator 102. Assuming no accidental degeneracies, besides possible polarization degeneracy, each mode resonates at a respective resonant frequency fₘ. The index m denotes the mode number.

For the described example of the photonic accelerometer 100 in FIGS. 1A-1B, resonator 102 is a ring resonator and the modes are whispering-gallery modes (WGMs). For constructive interference and thus resonance to occur, the optical path length (2πRn_{eff}) of photons circulating in the ring resonator 102 equals an integer number of wavelengths A. This is the resonance condition (at a first-order approximation):

2πRn_{eff}=mλₘ

Here, R is the radius of the ring resonator 102, n_{eff} is the effective refractive index, m is an integer, and fₘ=c/λₘ is the corresponding resonant frequency of a WGM. c being the speed of light. The effective refractive index n af is related to the phase velocity of light within the ring resonator 102, which is influenced by various factors such as its cross-sectional geometry (e.g., rectangular or circular) and refractive indices n and n_{clad}, all of which can be tuned as desired. The first-order approximation is sufficiently accurate for R>>λ A but additional corrections can be included when, for example, the radius of the ring resonator 102 is on the order of the wavelength of light.

As shown in the above equation, the resonant frequencies depend, at least in part, on the morphology of the resonator 102 which includes the radius R and the refractive index n through n_{eff}. Changes in the morphology, R→R+ΔR and n_{eff}→>n_{eff}+Δn_{eff}, lead to shifts in the resonant frequencies fₘ→fₘ+Δfₘ:

$$\frac{{Δλ}_{m}}{{λ}_{m}} = - \frac{Δ {f}_{m}}{{f}_{m}} = \frac{Δ R}{R} + \frac{Δ {n}_{eff}}{{n}_{eff}}$$

ΔR/R˜ϵₓₓ is a measure of the local strain 124 and An eff/neff is a contribution from the photoelastic effect. Δn_{eff}/n_{eff} can be calibrated for sensing but is usually negligible compared to the strain ΔR/R>>Δn_{eff}/n_{eff}. The strain 124 alters the optical path length of photons circulating in the resonator 102, shifting the resonant frequencies as a result. For the described example of the accelerometer 100, dominant sources of measurement uncertainty may include thermal noise due to a large thermo-optic coefficient of the resonator 102′s material, shot-noise, and quantization noise introduced through digitization of optical signals. Quantization noise can be appropriately reduced, e.g., in analog-to-digital converter (ADC) stages, by using high bitrates, oversampling, and/or dithering, such that thermal and/or shot-noise are the main uncertainty sources.

Considering the EB beam theory outlined above, the mode shifts are linearly proportional to the free end 132 tip displacement q=AΔfₘ/fₘ, where A is a proportionally constant (with units of length) that characterizes, at least in part, the measurement sensitivity of the accelerometer 100. Hence, mode shifts provide a direct measurement of the deflections 122 and therefore the motion 120 of the base 108. Since mode shifts measure deflections 122 directly, the signal-to-noise ratio of accelerometer 100 does not depend on the amplitude of accelerations that generate the defections 122. Accelerometer 100 can therefore measure small and/or slowly-varying motion 120 over an extended period of time.

In general, the resonator 102 can be any photonic resonator of sufficiently high quality, including linear (one-dimensional), planar (two-dimensional), and three-dimensional resonators. A few non-limiting examples of resonators 102 that can be used for accelerometer 100 include spherical resonators, disk resonators, square or rectangular resonators, Fabry-Perots, cavity resonators, microwave resonators, transmission line resonators, among other types of resonators. The electromagnetic modes and resonant frequencies of all such resonators depend on their respective morphology and therefore will exhibit resonant frequency shifts in some manner when they are deformed. Nevertheless, as mentioned previously, ring resonators of various shapes (e.g., circular, racetrack, looped, etc.) are advantageous due to their planar geometry, making them particularly amenable to microfabrication techniques. Moreover, when considering the example ring resonator 102, the resonant wavelengths λₘ are (to good approximation) linear in both R and n_{eff} which can be valuable for strain 124 sensing and metrology in general.

Along similar lines, the waveguide 104 can be any suitable waveguide capable of coupling to the resonator 102, e.g., an optical fiber, a graded index fiber, a microwave waveguide, a square or rectangular waveguide, etc. The primary function of waveguide 104 is to excite one or more modes of the resonator 102 with resonant photons which can be achieved by a variety of methods. In most cases, single-mode waveguide operation is generally desirable to eliminate the drawbacks associated with multi-mode waveguide operation (e.g., modal distortion). Single-mode operation can be particularly valuable if photonic accelerometer 100 is operated remotely and/or is incorporated into a network of multiple sensors, e.g., using fiber-optic communications (see FIG. 8 for example).

Referring again to the coupling coefficient κ between resonator 102 and waveguide 104. When the frequency of light propagated by the waveguide 104 is near a resonance f≈fₘ, the magnitude of the coupling κ can be well-approximated as a Lorentzian function,

$${\vert κ \vert}^{2} \approx \frac{{\vert {B}_{m} \vert}^{2} {f}_{m}^{2}}{{( f - {f}_{m} )}^{2} + {( {Q}_{m}^{- 1} {f}_{m} / 2 )}^{2}}$$

Bₘ is the amplitude of the coupling constant which depends on the mode m and relative configuration of resonator 102 to waveguide 104. The amplitude Bₘ can be tuned for any particular mode by adjusting, e.g., the refractive indices, dimension, and/or distance between resonator 102 and waveguide 104, etc. An optical quality factor Qₘ corresponds to a spectral line width δfₘ=fₘ/Qₘ of the resonance, which is related to the average photon lifetime in the mode. In general, light leakage occurs in the resonator 102 through several loss effects that limit the quality factor. Material loss, various scattering losses, radiation loss, and extrinsic loss, are typically the four main loss mechanisms in photonic resonators, all of which can be minimized to a degree by suitable geometrical and material design choices.

Qₘ is associated with the resolution of the resonator 102 when operating in a particular mode m. Narrower line widths (higher Qₘ) allow for the detection of smaller mode shifts, thus, higher measurement resolution. More particularly, when a resonant frequency is shifted fₘ→fₘ+Δfₘ due to strain 124, a corresponding peak of |κ|² is also shifted in response. Using narrow line widths, the difference between initial and shifted peaks can be measured by accelerometer 100 to high resolution. In this manner, the motion 120 of the base 108 is accurately assessed from the mode shift. For WGMs, the optical quality factor Qₘ can be about 10² or more (e.g., about 10⁸ or more, about 10⁹ or more, about 10¹⁰ or more). Accordingly, ring resonators can facilitate high resolution photonic based strain 124 sensing.

FIG. 2 is a schematic view of an example measurement system 200 that can continuously monitor a mode shift of a photonic accelerometer, e.g., the photonic accelerometer 100 of FIGS. 1A-1B, to characterize time-varying motion of an object.

System 200 measures resonant frequency shifts Δf by generating transmission spectrums 230 within a frequency interval (frequency band) at multiple time steps. The frequency band can correspond to any preferred electromagnetic band, e.g., a telecommunications band, a millimeter wave band, a visible band, a radio frequency band, etc. The location of a dip in the transmission |t|²≈1−|κ|² at one time step corresponds to an initial resonant frequency fₘ. The location of the dip at a second time step corresponds to a shifted resonant frequency fₘ′. The mode shift is assessed by system 200 from the difference fₘfₘ′=Δf at successive time steps which, as outlined previously, directly relates to the motion of the object.

To accomplish this task, system 200 includes a light source 202 that supplies photons 222 to an input 105A of the waveguide 104 of the accelerometer 100. A photodetector 204 collects photons 224 from an output 105B of the waveguide 104. Waveguide 104 can be coupled to other optical lines of system 200 with appropriate optical interfaces, e.g., fiber-optic pigtails. In general, light source 202 can supply polychromatic photons (e.g., using a white light source or a supercontinuum laser) or monochromatic photons (e.g., using a conventional laser). For example, at each time step, the light source 202 can emit polychromatic light having a suitable central frequency and optical bandwidth. Alternatively, the light source 202 can supply monochromatic light at a tunable frequency that can be scanned within the frequency band at each time step. The latter approach can be particularly advantageous since tunable lasers, e.g., tunable diode lasers, can be scanned at relatively high rates. Moreover, a photodetector 204 calibrated for polychromatic operation (e.g., frequency selectivity) can be costly and/or impractical.

Examples of light sources 202 can include, but are not limited to, liquid or gas lasers, liquid-crystal lasers, solid-state lasers, semiconductor lasers (e.g., Fabry-Perot lasers, distributed feedback (DFB) lasers, and Vertical Cavity Surface Emitting Lasers (VCSELs), diode lasers, dye lasers, fiber lasers, chemical lasers, excimer lasers, among other types of lasers. Examples of photodetectors 204 can include, but are not limited to, photodiodes, p-i-n photodetectors, Schottky barrier photodetectors, metal-semiconductor-metal (MSM) photodetectors, photoconductors, phototransistors, avalanche photodetectors (APDs), single-photon avalanche diodes (SPADs), among other solid-state and semiconductor devices.

The waveguide 104 is configured to guide photons 226 from the input 105A to the output 105B in order to interface with the resonator 102 of the accelerometer 100. Resonant photons, that is, photons with frequencies on resonance with a particular mode m of the resonator f=fₘ, are strongly coupled into the mode. The relative number of resonant photons coupled into the mode is governed, at least in part, by the coupling coefficient κ and corresponds to the dip in the transmission spectra 230. For example, if the tunable frequency of light source 202 is scanned over a resonant frequency, some fraction of resonant photons will be stored 228 in the resonator 102 (and eventually dissipate by one or more loss mechanisms) while any remaining photons will be detected at the photodetector 204. At each time step, system 200 can calculate the difference between supplied photons 222 and collected photons 224 at multiple monochromatic frequencies in the frequency band to generate the transmission spectrum 230.

To do so, system 200 includes an electronic control module 206 communicatively coupled with the light source 202 and the photodetector 204. For example, control module 206 can include: (i) a waveform generator (e.g., a local oscillator), and (ii) a light source driver (e.g., a laser controller) coupled to the light source 202 and the waveform generator. The light source driver can modulate the frequency of light generated by the light source 202 according to waveforms (e.g., sawtooth waveforms) generated by the waveform generator. Although not shown in FIG. 2, in some examples, system 200 may also include a beam splitter to divide (e.g., 80:20, 85:15, 90:10, 95:5) the supplied photons 222 into: (i) a measurement signal that interacts with the accelerometer 100, and (ii) a reference signal that can be collected by another photodetector communicatively coupled with the control module 206. In these cases, control module 206 can use the reference signal to implement homodyning and other types of amplitude, phase, and/or frequency corrected detection. For example, control module 206 can use the reference signal to remove the modulation profile on the measurement signal induced by the waveform generator. Control module 206 can also include an analog-to-digital converter (ADC) to digitize the received signals from the photodetector(s) 204, facilitating the digital signal processing described below.

In general, the control module 206 is programmed to correlate supplied photons 222 with collected photons 224 to determine the mode shifts within the selected frequency band. For example, among other approaches, the control module 206 can implement dip detection (DD), cross correlation (CC), or Lorentzian fitting (LF) to monitor mode shifts. DD tracks the location of the minimum of the resonance dip signal. In the CC approach, a reference and a shifted mode dip are cross correlated, and the mode shift is determined from the location of the peak of the correlation output. The LF method relies on fitting a Lorentzian function to the mode dip to estimate the center and width of the resonance. Although DD is generally the fastest algorithm, it is also the most susceptible to noise because it only tracks the location of the signal minimum which can exhibit dithering. The CC algorithm can exhibit better performance, with lower noise than DD, but at the expense of increased computation time. LF is a robust algorithm because it uses the overall profile of the resonance instead of a single point. However, this is at the expense of computation time and resources because it is an iterative process. For real-time applications, both DD and CC are suitable, with CC generally preferred because it can be configured for measurements exceeding the free-spectral-range of the resonator 102.

Computations performed by electronic control module 206 can be relatively inexpensive (e.g., when DD or CC algorithms are implemented) which is particularly advantageous for remote sensing applications where computational resources are usually limited. For example, a dedicated digital and/or analog circuit (e.g., an application-specific integrated circuit (ASIC)), or a minicomputer such as a Raspberry Pi 4, can be implemented as (or a component of) the control module 206 to facilitate contemporaneous (or near-contemporaneous) mode shift monitoring.

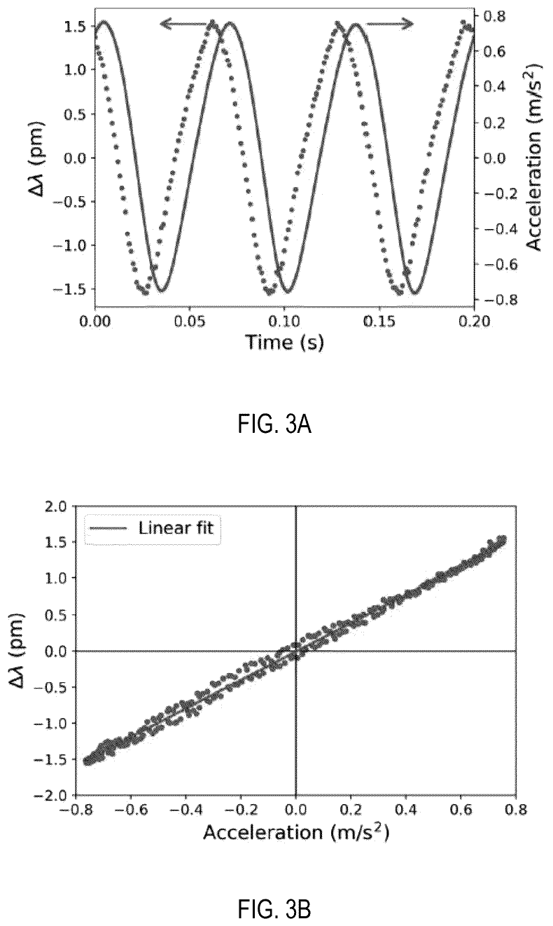

FIGS. 3A and 3B are plots of experimental data showing mode shifts vs. acceleration of an object. The plots were generated by a measurement system that was configured in accordance with the example measurement system 200 in FIG. 2. The experimental data reflects the performance of a prototype photonic accelerometer that was configured as the example photonic accelerometer 100 in FIGS. 1A-1B, demonstrating the efficacy of the disclosed photonic sensors.

A photonic chip based cantilever of the prototype accelerometer was composed of a layer of silicon substrate supporting a thin layer of silica cladding. A silicon nitride waveguide and ring resonator were embedded in the silica cladding. The dimensions of the photonic chip were 27 millimeters (mm), 25 mm, and 1 mm measured in the x, y, and z directions, respectively, with reference to FIGS. 1A-1B. The cantilever overhang was L=11 mm and the radius of the ring resonator was R=12 mm.

A vibration table was used to calibrate the prototype accelerometer following the procedure described by Wielandt, E. (2012), “Seismic Sensors and their Calibration,” in New Manual of Seismological Observatory Practice 2, Deutsches GeoForschungsZentrum, Germany, Chap. 5, 1-51. The prototype accelerometer had a base rigidly connected to the vibration table and the motion of the vibration table was controlled by a harmonic signal (15 Hz sinusoidal waveform) generated by a waveform generator.

In this preliminary experiment, a 25-gram (g) proof mass was supported by the cantilever and no additional damping was employed. A 1313 nanometer (nm) tunable diode laser was scanned at a rate of 1 kilohertz (kHz). Transmission spectrums were acquired at five thousand samples per cycle of the laser (or five million samples per second), which was sufficient to resolve whispering-gallery mode (WGM) dips. Each scan of the laser yielded a single point in the time evolution of the WGM resonance shift, resulting in sixty-seven WGM data points per cycle of the table oscillation. The time variation of the WGM shift and the corresponding accelerometer output is shown in FIG. 3A. The results illustrate the effectiveness of monitoring motion by tracking mode shifts.

As shown in FIG. 3A, harmonic motion of the base caused a harmonic shift of the WGM. The phase difference between the two signals was attributed to the distinct mechanical impedances of the two systems. The two signals were aligned by a CC-based algorithm and the mode shift was plotted against the measured acceleration of the table in FIG. 3B. The linear fit yielded a sensitivity (slope of the plot in FIG. 3B) of 1.97 picometers per meter per second squared (pm/m/s²), with a 2% root mean square error (or 0.062 m/s²).

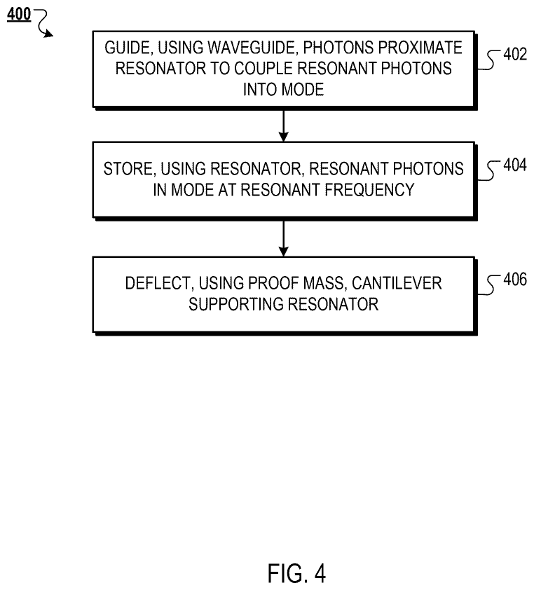

FIG. 4 is a flow diagram of an example process 400 for measuring motion of an object. For convenience, the process 400 will be described as being performed by a photonic accelerometer, e.g., the photonic accelerometer 100 of FIGS. 1A-1B.

Accelerometer guides, using a waveguide, photons proximate a resonator to couple resonant photons into a mode supported by the resonator (402).

Accelerometer stores, using the resonator, the resonant photons in the mode at a resonant frequency (404). Resonant photons eventually dissipate from the resonator due to a combination of one or more loss mechanisms.

Accelerometer deflects, using a proof mass, a cantilever supporting the resonator (406). The cantilever includes: (i) a first end fixed to a base, and (ii) a second, free end supporting a proof mass. The base is secured to the object and the proof mass is configured to deflect the cantilever based on motion of the base. Deflections of the cantilever causing shifts of the resonant frequency.

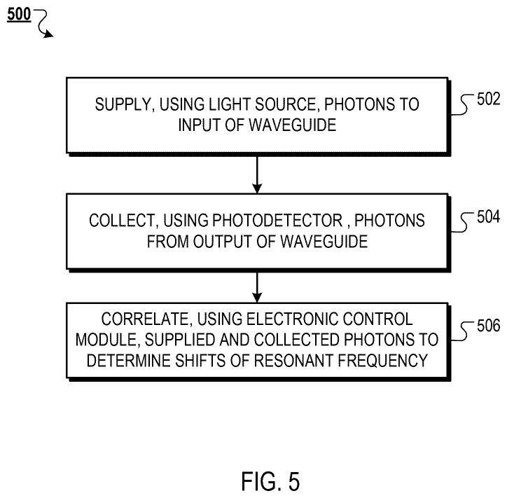

FIG. 5 is a flow diagram of an example process 500 for determining resonant frequency shifts of a photonic accelerometer, e.g., the photonic accelerometer 100 of FIGS. 1A-1B. For convenience, the process 500 will be described as being performed by a measurement system, e.g., the measurement system 200 of FIG. 2.

System supplies, using a light source, photons to an input of a waveguide of the photonic accelerometer (502).

System collects, using a photodetector, photons from an output of the waveguide (504).

System correlates, using an electronic control module communicatively coupled with the light source and photodetector, supplied and collected photons to determine the shifts of the resonant frequency (506). System can use, for example, dip detection (DD), cross correlation (CC), or Lorentzian fitting (LF) algorithms to determine the resonant frequency shifts.

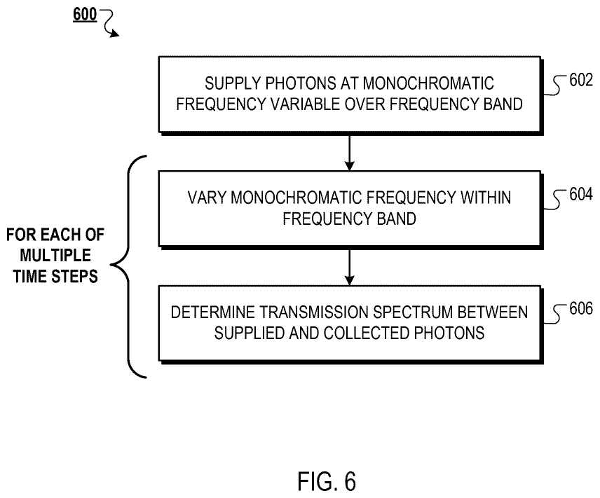

FIG. 6 is a flow diagram of an example process 600 for generating transmission spectrums of a photonic accelerometer, e.g., the photonic accelerometer 100 of FIGS. 1A-1B. For convenience, the process 600 will be described as being performed by a measurement system, e.g., the measurement system 200 of FIG. 2.

Light source supplies photons at a monochromatic frequency variable over a frequency band (602).

For each of multiple time steps:

Electronic control module varies the monochromatic frequency over the frequency band (604).

Electronic control module determines a transmission spectrum between: (i) photons suppled to the input of the waveguide, and (ii) photons collected from the output of the waveguide (606).

FIG. 7 is an isometric view of an example triaxial photonic accelerometer 700 that can measure motion of an object in three mutually orthogonal directions, e.g., x, y, and z directions. To accomplish this, triaxial accelerometer 700 includes three photonic accelerometers 100-X, 100-Y, and 100-Z, e.g., three of the example photonic accelerometer 100 shown in FIGS. 1A-1B.

Three cantilevers 110-X, 110-Y, and 110-Z support respective proof masses 106-X, 106-Y, and 106-X at their free ends and are each fixed at their opposing ends to a common base 108. Proof masses 106-X/Y/Z can have different sizes and positions about the free ends of their respective cantilevers 110-X/Y/Z. However, unless some preferred direction of motion exists, uniform dimensions and mechanical properties between the cantilevers 110-X/Y/Z of the accelerometers 100-X/Y/Z can be desirable to maintain similar sensitivities and bandwidths for measurement in all three directions.

The cantilevers 110-X/Y/Z are single-axis devices but are arranged such that they deflect 122-X/Y/Z in mutually orthogonal directions based on three-dimensional motion 120-XYZ of the base 108. Hence, the triaxial accelerometer 700 can monitor motion 120-XYZ in three directions simultaneously. Particularly, accelerometer 110-X can measure motion in the x direction, accelerometer 110-Y can measure motion in they direction, and accelerometer 110-Z can measure motion in the z direction. Triaxial accelerometer 700 can also be combined with one or more gyroscopes to measure rotations about each of the x, y, and z axes.

To measure motion, each cantilever 110-X, 110-Y, and 110-Z supports a respective resonator 102-X, 102-Y, and 102-Z that deforms in response to defections 122-X, 122-Y, and 122-Z in a corresponding one of the three directions. The resonant frequency shifts of the resonators 102-X/Y/Z can be monitored by respective waveguides 104-X/Y/Z coupled to the resonators 102-X/Y/Z. In this case, some variability between the resonators 102-X/Y/Z can be beneficial depending on how the mode shifts are detected. For example, if the waveguides 104-X/Y/Z are daisy-chained together, e.g., via fiber-optic pigtails, resonators 102-X/Y/Z can be tuned to support resonant frequencies in different regions of the frequency spectrum. In this way, shifts of the resonant frequencies can be monitored independently without overlapping with one another.

FIG. 8 is a schematic view of an example sensor network 800 that includes an array of N frequency-division multiplexed photonic accelerometers 100-1...N. Each photonic accelerometer 100 is configured similarly to that of FIGS. 1A-1B. Using different sized proof masses 106-1 . . . N, different resonators 102-1 . . . N, and/or different materials and dimensions for each accelerometer 100-1 . . . N, network 800 can monitor motion, e.g., seismic activity, in multiple bandwidths and physical locations simultaneously.

The accelerometers 100-1 . . . N are daisy-chained together, e.g., via fiber-optic pigtails, that connects inputs 105A-1 . . . N and outputs 105B-1 . . . N of the waveguides 104-1 . . . N to other optical lines of network 800. Due to the efficiency of telecommunication systems, the accelerometers 100-1 . . . N can be located at relatively large distances from each other and/or an electronic control module 206. Alternatively, two or more of the accelerometers 100-1...N can be located in a common location to measure motion at the common location in two or more directions. For example, the network 800 can be configured for the triaxial accelerometer 700 in FIG. 7, where three of the accelerometers 100-1 . . . N correspond to the three accelerometers 100-X, 100-Y, and 100-Z.

Here, the control module 206 is communicatively coupled with an array of N light sources 202-1...N and an array of N photodetectors 204-1 . . . N. Network 800 includes a respective light source 202 and corresponding photodetector 204 for each accelerometer 100. Each light source 202 can be configured to supply photons within a respective frequency band and the corresponding photodetector 204 can be configured to receive photons within the respective frequency band. A resonator 102 of the corresponding accelerometer 100 can be configured to support a mode residing in the frequency band and monitor motion at its particular location via resonant frequency shifts of the mode.

Utilizing the high optical bandwidths available to telecommunications systems, network 800 can supply and collect photons in each of the frequency bands along a single channel using a multiplexer (MUX) 810 and a demultiplexer (DEMUX) 820. Particularly, the MUX 810 can receive the photons supplied by each of the light sources 202-1 . . . N and frequency-multiplex them into a multiplexed input signal 222 which interacts with the accelerometers 100-1 . . . N. Since, each accelerometer 100 is tuned to a respective frequency band, in general, the accelerometer 100 only couples to and stores resonant photons of the input signal 222 within that particular band, allowing the photons in the other bands to be transmitted. Thus, the array of accelerometers 100-1 . . . N are frequency selective. The DEMUX 820 can receive a multiplexed output signal 224 that includes the photons in each frequency band that were transmitted. The DEMUX 820 can demultiplex the output signal 224 into each of the frequency bands which are collected by their respective photodetectors 204-1 . . . N. As described in more detail with reference to FIG. 2, the control module 206 can then generate respective transmission spectrums 230-1...N for each of the accelerometers 100-1 . . . N to determine the corresponding resonant frequency shifts, thereby monitoring motion in multiple locations simultaneously.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results.

What is claimed is:

1. A photonic accelerometer, comprising:
a resonator;
a waveguide evanescently coupled to the resonator;
a cantilever supporting the resonator, the cantilever comprising: (i) a first end fixed to a base, and (ii) a second, free end; and
a proof mass supported by the free end of the cantilever.

2. The photonic accelerometer of claim 1, wherein the resonator is a ring resonator, a disk resonator, or a transmission line resonator.

3. The photonic accelerometer of claim 1, wherein the resonator is supported by the cantilever and the base, and the waveguide is supported by the base.

4. The photonic accelerometer of claim 1, wherein:
the resonator is configured to store resonant photons in a mode at a resonant frequency;
the waveguide is configured to guide photons proximate the resonator to couple resonant into the mode; and
the proof mass is configured to deflect the cantilever based on motion of the base, deflections of the cantilever causing shifts of the resonant frequency.

5. The photonic accelerometer of claim 4, wherein:
the deflections of the cantilever change a morphology of the resonator, and
the resonant frequency depends, at least in part, on the morphology of the resonator.

6. The photonic accelerometer of claim 5, wherein the morphology of the resonator comprises at least one of: (i) a dimension of the resonator, or (ii) a refractive index of the resonator.

7. The photonic accelerometer of claim 4, further comprising:
a light source configured to supply photons to an input of the waveguide; and
a photodetector configured to collect photons from an output of the waveguide.

8. The photonic accelerometer of claim 7, further comprising:
an electronic control module communicatively coupled with the light source and photodetector,
wherein the electronic control module is configured to correlate supplied and collected photons to determine the shifts of the resonant frequency.

9. The photonic accelerometer of claim 8, wherein:
the light source is configured to supply photons at a monochromatic frequency variable over a frequency band, and
the electronic control module is configured, for each of a plurality of time steps, to:
vary the monochromatic frequency over the frequency band; and
determine a transmission spectrum between: (i) photons supplied to the input of the waveguide, and (ii) photons collected from the output of the waveguide.

10. The photonic accelerometer of claim 7, wherein the light source is a diode laser, a dye laser, or a semiconductor laser.

11. The photonic accelerometer of claim 1, wherein:
the cantilever is a photonic chip comprising a layer of cladding and a layer of substrate,
the resonator and waveguide are embedded in the layer of cladding, and
the layer of substrate is attached to the base.

12. The photonic accelerometer of claim 11, wherein the layer of cladding comprises silica, and the layer of substrate comprises silicon.

13. The photonic accelerometer of claim 1, wherein the waveguide is a dielectric waveguide.

14. The photonic accelerometer of claim 13, wherein the dielectric waveguide comprises at least one of: silicon or silicon nitride.

15. The photonic accelerometer of claim 1, wherein the resonator comprises at least one of:
silicon or silicon nitride.

16. A method for measuring motion of an object using a photonic accelerometer, the photonic accelerometer comprising:
a resonator;
a waveguide evanescently coupled to the resonator;
a cantilever supporting the resonator, the cantilever comprising: (i) a first end fixed to a base, and (ii) a second, free end,
wherein the base is secured to the object; and
a proof mass supported by the free end of the cantilever, the method comprising:
guiding, using the waveguide, photons proximate the resonator to couple resonant photons into a mode supported by the resonator;
storing, using the resonator, the resonant photons in the mode at a resonant frequency; and
deflecting, using the proof mass, the cantilever based on motion of the base, deflections of the cantilever causing shifts of the resonant frequency.

17. The method of claim 16, further comprising:
supplying, using a light source, photons to an input of the waveguide; and
collecting, using a photodetector, photons from an output of the waveguide.

18. The method claim 17, further comprising:
correlating, using an electronic control module communicatively coupled with the light source and photodetector, supplied and collected photons to determine the shifts of the resonant frequency.

19. The method of claim 18, wherein:
the light source is configured to supply photons at a monochromatic frequency variable over a frequency band, and
the electronic control module is configured, for each of a plurality of time steps, to:
vary the monochromatic frequency over the frequency band; and
determine a transmission spectrum between: (i) photons supplied to the input of the waveguide, and (ii) photons collected from the output of the waveguide.

20. A triaxial photonic accelerometer, comprising:
a base configured to move in three mutually orthogonal directions; and
three photonic accelerometers each comprising:
a resonator;
a waveguide evanescently coupled to the resonator;
a cantilever supporting the resonator, the cantilever comprising: (i) a first end fixed to the base, and (ii) a second, free end; and
a proof mass supported by the free end and configured to deflect the cantilever in one of the three mutually orthogonal directions.
